(19) United States
(12) Patent Application Publication
(10) Pub. No.: US 2013/0164611 A1
(43) Pub. Date: Jun. 27, 2013

(54) POWER STORAGE DEVICE

(71) Applicant: SEMICONDUCTOR ENERGY LABORATORY CO., LTD., Atsugi-shi (JP)

(72) Inventors: Kenryo NANBA, Tokyo (JP); Minoru Takahashi, Matsumoto (JP); Ryota Tajima, Isehara (JP); Teppei Oguni, Atsugi (JP); Junpei Momo, Sagamihara (JP)

(73) Assignee: SEMICONDUCTOR ENERGY LABORATORY CO., LTD., Atsugi-shi (JP)

(21) Appl. No.: 13/717,750

(22) Filed: Dec. 18, 2012

(30) Foreign Application Priority Data
Dec. 23, 2011 (JP) 2011-282506

(51) Int. Cl. H01M 4/70

(52) U.S. Cl. CPC H01M 4/70
USPC 429/211

(57) ABSTRACT

Disclosed is a power storage device including a negative electrode and a positive electrode. The negative electrode includes a negative electrode current collector including a common portion and a plurality of protrusions protruding from the common portion, and a negative electrode active material layer which covers a side surface of the protrusion. The positive electrode faces the negative electrode with an electrolyte provided therebetween. In the plurality of protrusions, a distance between adjacent protrusions is a distance with which adjacent negative electrode active material layers are in contact with each other before the capacity of the negative electrode active material layer reaches the theoretical capacity of the negative electrode active material layer by insertion of carrier ions from the positive electrode.

### BACKGROUND OF THE INVENTION

1. Field of the Invention

The present invention relates to a power storage device.

2. Description of the Related Art

In recent years, power storage devices such as lithium-ion secondary batteries, lithium-ion capacitors, and air cells have been developed.

A negative electrode for a power storage device includes an active material layer over one surface of a current collector. As a negative electrode active material included in the negative electrode active material layer, for example, a material which can absorb and release ions serving as carriers (hereinafter referred to as carrier ions), such as carbon, silicon, germanium, tin, aluminum, or the like, is used. Silicon, germanium, tin, and aluminum, for example, can each absorb about two to four times as many carrier ions as carbon. Thus, with the use of a negative electrode active material layer which is formed using any of the above materials, a power storage device can have high capacity.

A conventional negative electrode active material layer is formed over a current collector in the following manner: particulate negative electrode active materials, conductive auxiliary agent, and slurry containing a binder are applied to the current collector and then dried. However, as the amount of carrier ions absorbed by the particulate negative electrode active materials is increased, the volumes of the particulate negative electrode active materials are increased. As a result, the negative electrode active material layer which has absorbed a large amount of carrier ions is distorted, and this causes a problem of breakdown of the negative electrode active material layer. In addition, the increase in volume due to absorption of carrier ions leads to a decrease in adhesion between the current collector and the active material layer, which might cause a problem of deterioration of battery characteristics.

To increase the charge-discharge capacity of a power storage device and extend the lifetime thereof, a negative electrode including, as a current collector, metal foil, which has conductive protrusions, and a thin-film negative electrode active material layer which is provided over a surface of the current collector is disclosed. In the negative electrode, a space between the adjacent conductive protrusions is 10 μm to 100 μm both inclusive and the thin-film negative electrode active material layer is formed using an alloy containing one or more of silicon, tin, antimony, aluminum, lead, and arsenic (see Patent Document 1).

Note that a high-power storage device is repeatedly charged and discharged with a large current flow. To obtain high power in a storage device, the area of a region where a positive electrode and a negative electrode face each other needs to be increased and the resistances of the positive electrode and the negative electrode need to be reduced.

### REFERENCE

### Patent Document

[Patent Document 1] Japanese Published Patent Application No. 2010-262843

### SUMMARY OF THE INVENTION

In the conventional negative electrode active material layer which is formed by application of the particulate negative electrode active materials, the conductive auxiliary agent, and the slurry containing the binder to the current collector and drying, variation in resistance might occur in a plane of the negative electrode active material layer which results from variation in distribution of the conductive auxiliary agent. As a result, carrier ions are locally inserted into a region with small resistance in the negative electrode active material layer. Thus, the uniformity of an electrode reaction is decreased and an excessive increase in volume and breakdown due to the excessive increase in volume occur in a region into which a larger amount of carrier ions is inserted, which causes deterioration of the negative electrode.

Further, a high current flow concentrates in the region into which carrier ions are locally inserted. This might cause heat generation in the power storage device, and a safety problem of the power storage device arises.

In the thin-film negative electrode active material layer formed over the conductive protrusions and the metal foil having the conductive protrusions, on the other hand, the amount of carrier ions to be inserted needs to be controlled in the case where a space between the adjacent protrusions is as large as 10 μm or more and 100 μm or less. Otherwise, carrier ions are continuously inserted into the thin-film negative electrode active material layer and thus, the volume of the thin negative electrode active material layer is increased and distortion occurs, which cause deterioration of the negative electrode.

In view of the above, one embodiment of the present invention is a power storage device in which variation in electrode reaction in a plane is reduced. Further, one embodiment of the present invention provides a power storage device in which charge-discharge capacity is high and deterioration of battery characteristics due to charge-discharge is small.

One embodiment of the present invention is a power storage device which includes a negative electrode and a positive electrode. The negative electrode includes a negative electrode current collector including a common portion and a plurality of protrusions protruding from the common portion, and a negative electrode active material layer which covers a side surface of the protrusion. The positive electrode faces the negative electrode with an electrolyte provided therebetween. In the plurality of protrusions, a distance between adjacent protrusions is a distance with which adjacent negative electrode active material layers are in contact with each other before the capacity of the negative electrode active material layer reaches the theoretical capacity of the negative electrode active material layer by insertion of carrier ions from the positive electrode.

One embodiment of the present invention is a power storage device which includes a negative electrode and a positive electrode. The negative electrode includes a negative electrode current collector including a common portion and a plurality of protrusions protruding from the common portion, a negative electrode active material layer which covers a side surface of the protrusion, and a surface coating film which covers the negative electrode active material layer. The positive electrode faces the negative electrode with an electrolyte provided therebetween. In the plurality of protrusions, a distance between adjacent protrusions is a distance with which adjacent parts of the surface coating film are in contact with each other before the capacity of the negative electrode active material layer reaches the theoretical capacity of the negative electrode active material layer by insertion of carrier ions from the positive electrode.

Note that “before the capacity of the negative electrode active material layer reaches the theoretical capacity of the negative electrode active material layer by insertion of carrier ions from the positive electrode” can also mean “before the amount of carrier ions which are inserted into the negative electrode active material layer reaches the maximum absorption amount of carrier ions of the negative electrode active material layer”.

One embodiment of the present invention is a power storage device which includes a negative electrode and a positive electrode. The negative electrode includes a negative electrode current collector including a common portion and a plurality of protrusions protruding from the common portion, and a negative electrode active material layer which covers a side surface of the protrusion. The positive electrode faces the negative electrode with an electrolyte provided therebetween. In the plurality of protrusions, a distance d between adjacent protrusions is expressed by Formula 1.

$$d = 2 \times \{ r + t \times [ \frac{( {α}_{m} - 1 )}{{C}_{i}} \times {C}_{l} + 1 ] \} \qquad [ FORMULA 1 ]$$

In Formula 1, r is a half of the narrowest width of a top surface shape of the protrusion. In the case where the top surface shape of the protrusion is a circle, r is a radius of the circle. Further, t, αₘ, Cᵢ, and Cₗ represent a thickness of the negative electrode active material layer before carrier ions are inserted thereto, the maximum rate of increase in volume of the negative electrode active material layer, the theoretical capacity of the negative electrode active material layer, and the capacity of the negative electrode active material layer when adjacent negative electrode active material layers each formed on a side surface of the protrusion are in contact with each other, respectively.

Note that in this specification, a distance between adjacent protrusions refers to the distance between the centers of the adjacent protrusions.

For the negative electrode active material layer, one or more of silicon, germanium, tin, aluminum, and the like, which can absorb and release carrier ions, may be used. Alternatively, silicon to which an impurity element imparting one conductivity type, such as phosphorus or boron, is added may be used for the negative electrode active material layer.

The amount of carrier ions to be inserted into the negative electrode active material layer is limited so that the amount of carrier ions inserted into the negative electrode active material layer does not reach the theoretical capacity of the negative electrode active material layer, whereby the expansion of the negative electrode active material layer can be limited. Thus, even if adjacent negative electrode active material layers are in contact with each other, distortion of the negative electrode active material layer is small, so that breakdown of the negative electrode active material layer can be prevented. Further, in the case where adjacent negative electrode active material layers are in contact with each other, the area of the negative electrode active material layer which is exposed to the electrolyte is decreased, resulting in a decrease in the amount of carrier ions to be inserted into the negative electrode active material layer; thus, the resistance of the negative electrode active material layer is increased. At this time, a voltage of the power storage device is increased owing to the increase in the resistance. Charge of the power storage device can be stopped by determining a change in the voltage with the use of an external circuit. That is, one embodiment of the present invention includes the negative electrode current collector including the protrusions, and the distance between adjacent protrusions is controlled so that adjacent negative electrode active material layers are in contact with each other when the capacity thereof reaches a predetermined capacity to control the amount of carrier ions to be inserted into the negative electrode active material layer; thus, breakdown of the negative electrode active material layer can be prevented.

As described above, in the case where adjacent negative electrode active material layers are in contact with each other, the area of the negative electrode active material layer which is exposed to the electrolyte is decreased. Thus, the resistance is increased in a region whose area where the negative electrode active material layer is exposed to the electrolyte is small. As a result, a larger amount of carrier ions is inserted into a region whose area where the negative electrode active material layer is exposed to the electrolyte is large. When carrier ions are inserted into a region with a large cross section, the negative electrode active material layer is expanded and the contact area between adjacent negative electrode active material layers is increased; thus, the area of the negative electrode active material layer which is exposed to the electrolyte is decreased. As a result, in the negative electrode active material layer, a region into which a larger amount of carrier ions is inserted is gradually shifted, so that variation in the amount of carrier ions to be inserted in a plane of the negative electrode can be reduced. Thus, the uniformity of an electrode reaction can be increased and deterioration of an electrode can be reduced.

In one embodiment of the present invention, variation in electrode reaction in a plane of a power storage device can be reduced. Further, in one embodiment of the present invention, the charge-discharge capacity of a power storage device can be increased and deterioration of battery characteristics due to charge-discharge can be reduced.

### BRIEF DESCRIPTION OF THE DRAWINGS

FIGS. 1A and 1B are a top view and a cross-sectional view illustrating a negative electrode.

FIGS. 2A to 2C are a top view and cross-sectional views illustrating negative electrodes.

FIGS. 3A and 3B are cross-sectional views each illustrating a negative electrode.

FIG. 4 is a graph showing a relation between the rate α of increase in volume and the capacity C of a negative electrode active material layer.

FIGS. 5A and 5B are a perspective view and a cross-sectional view illustrating a power storage device.

FIGS. 6A to 6D are cross-sectional views illustrating a method for forming a negative electrode.

FIGS. 7A and 7B are a top view and a cross-sectional view illustrating a negative electrode.

FIGS. 8A to 8D are cross-sectional views illustrating a method for forming a negative electrode.

FIG. 9 is a cross-sectional view illustrating a negative electrode.

FIGS. 10A to 10C are diagrams illustrating a positive electrode.

### DETAILED DESCRIPTION OF THE INVENTION

Hereinafter, embodiments will be described with reference to drawings. However, the embodiments can be implemented with various modes. It will be readily appreciated by those skilled in the art that modes and details can be changed in various ways without departing from the spirit and scope of the present invention. Thus, the present invention should not be interpreted as being limited to the following descriptions of the embodiments.

### Embodiment 1

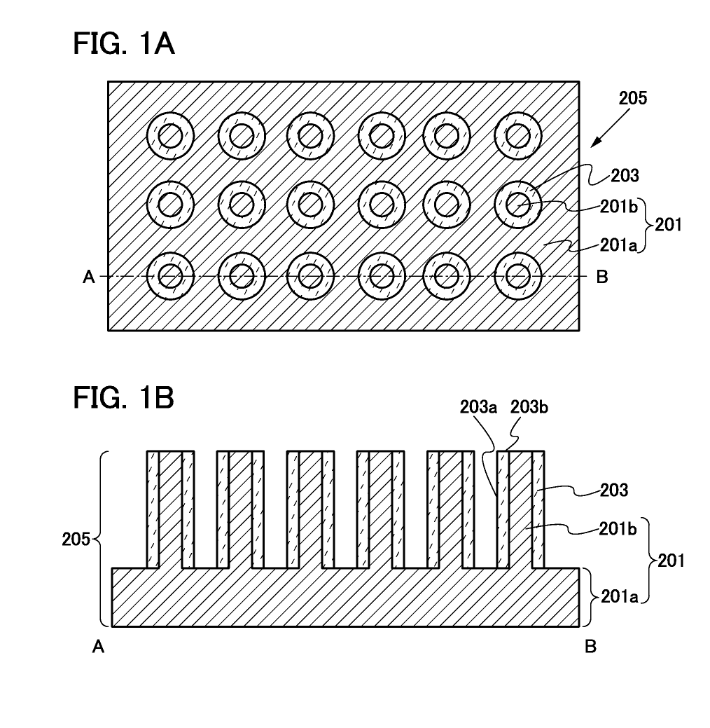

In this embodiment, the structure of a negative electrode in which deterioration of battery characteristics due to charge-discharge is small and a formation method thereof will be described with reference to FIGS. 1A and 1B, FIGS. 2A to 2C, FIGS. 3A and 3B, FIG. 4, and FIGS. 5A and 5B.

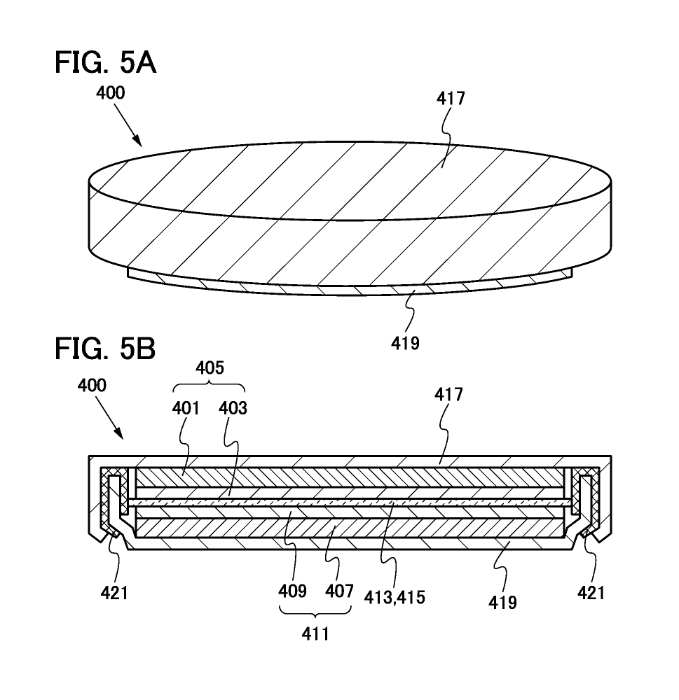

First, the structure of a power storage device will be described. Here, one embodiment of a lithium secondary battery which is a typical example of a power storage device in this embodiment will be described with reference to FIGS. 5A and 5B.

FIG. 5A is a perspective view of a coin-type lithium secondary battery 400. In the lithium secondary battery 400, an external terminal 417 and an external terminal 419 are provided with a gasket (not illustrated) provided therebetween.

FIG. 5B is a cross-sectional view of the coin-type lithium secondary battery 400 in a direction perpendicular to the top surface of the external terminal 417.

The lithium secondary battery 400 includes a positive electrode 405 including a positive electrode current collector 401 and a positive electrode active material layer 403, a negative electrode 411 including a negative electrode current collector 407 and a negative electrode active material layer 409, and a spacer 413 provided between the positive electrode 405 and the negative electrode 411. Note that an electrolyte 415 is contained in a hole in the spacer 413. Further, the positive electrode current collector 401 is connected to the external terminal 417, and the negative electrode current collector 407 is connected to the external terminal 419. An end portion of the external terminal 419 is embedded in a gasket 421. In other words, the external terminals 417 and 419 are insulated from each other with the gasket 421.

In this embodiment, the capacity of the negative electrode active material layer 409 is higher than that of the positive electrode active material layer 403. Accordingly, all carrier ions released from the positive electrode active material layer 403 can be inserted into the negative electrode active material layer 409. As a result, formation of a lithium dendrite on a surface of the negative electrode 411 can be prevented, so that deterioration of the lithium secondary battery 400 can be prevented. Note that the capacities of the positive electrode active material layer and the negative electrode active material layer can be controlled by materials of active materials included in the active material layers and the volumes of the active material layers.

Note that a state where carrier ions are released from the positive electrode 405 and the carrier ions are inserted into the negative electrode 411 is a charge state of the lithium secondary battery 400. The capacity generated in the lithium secondary battery 400 at this time is charge capacity. Further, a state where carrier ions are released from the negative electrode 411 and the carrier ions are inserted into the positive electrode 405 is a discharge state of the lithium secondary battery 400. The capacity generated in the lithium secondary battery 400 at this time is discharge capacity.

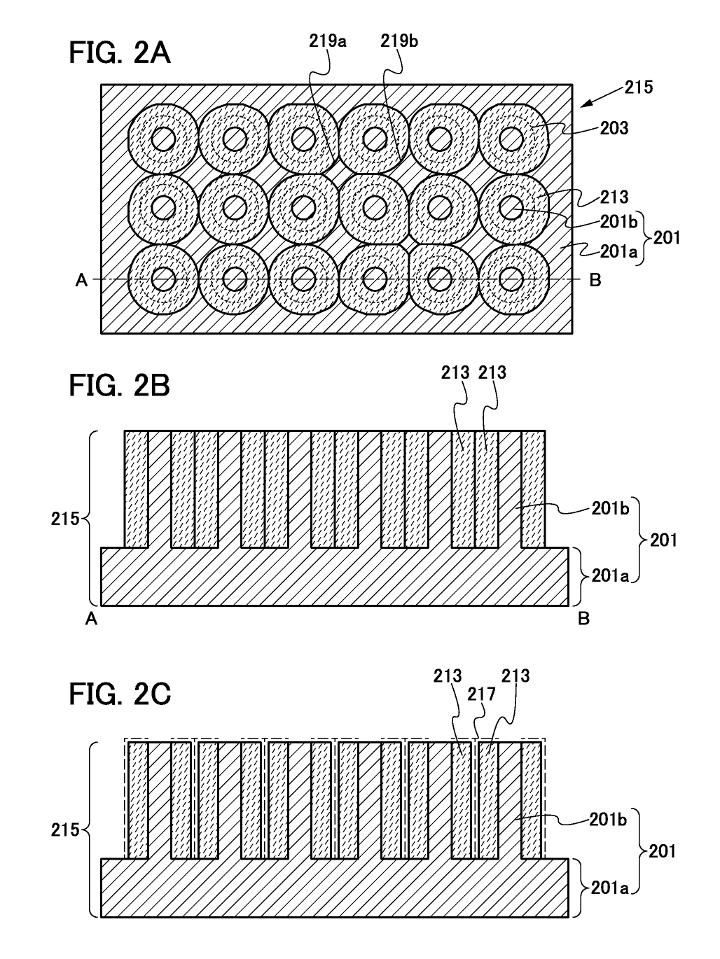

Next, details of the structure of a negative electrode will be described with reference to FIGS. 1A and 1B, FIGS. 2A to 2C, FIGS. 3A and 3B, and FIG. 4. FIGS. 1A and 1B illustrate the structure of a negative electrode in which carrier ions are not yet inserted into a negative electrode active material layer from a positive electrode (that is, a negative electrode before a battery is charged). FIGS. 2A to 2C each illustrate the structure of a negative electrode in which carrier ions have been inserted into a negative electrode active material layer from a positive electrode and adjacent negative electrode active material layers are in contact with each other (that is, a negative electrode after the battery is charged).

FIG. 1A is a top view of a negative electrode 205 and FIG. 1B is a cross-sectional view taken along dashed-dotted line A-B in FIG. 1A.

The negative electrode 205 includes a negative electrode current collector 201 and a negative electrode active material layer 203. The negative electrode current collector 201 has a common portion 201a and a plurality of protrusions 201b protruding from the common portion 201a. The negative electrode active material layer 203 is provided in contact at least with a side surface of the protrusion 201b. Further, the plurality of protrusions are arranged so that adjacent negative electrode active material layers are in contact with each other when the amount of carrier ions inserted into the negative electrode active material layer is smaller than the theoretical capacity of the negative electrode active material layer, that is, before the capacity of the negative electrode active material layer reaches the theoretical capacity of a negative electrode active material layer by insertion of carrier ions from the positive electrode. Note that “before the capacity of the negative electrode active material layer reaches the theoretical capacity of a negative electrode active material layer by insertion of carrier ions from the positive electrode” can also mean “before the amount of carrier ions which are inserted into the negative electrode active material layer reaches the maximum absorption amount of carrier ions of the negative electrode active material layer”.

Note that the term “active material” refers to a material that relates to absorption and release of carrier ions.

Examples of carrier ions include alkali-metal ions such as lithium ions, sodium ions, and potassium ions; alkaline-earth metal ions such as calcium ions, strontium ions, and barium ions; beryllium ions; and magnesium ions. A secondary battery in which lithium ions are used as carrier ions is referred to as a lithium secondary battery.

The negative electrode current collector 201 is formed using a material which is not alloyed with carrier ions in a potential region used as a current collector and has high corrosion resistance. The negative electrode current collector 201 can be formed using, for example, a material having high conductivity, such as a metal typified by stainless steel, gold, platinum, zinc, iron, aluminum, copper, or titanium, or an alloy thereof. Note that the negative electrode current collector 201 may have a stacked-layer structure. Alternatively, the negative electrode current collector 201 may be formed using an aluminum alloy to which an element which improves heat resistance, such as silicon, titanium, neodymium, scandium, or molybdenum, is added. Further alternatively, the negative electrode current collector 201 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, and nickel.

The negative electrode current collector 201 can have a foil-like shape, a plate-like shape (sheet-like shape), a net-like shape, a punching-metal shape, an expanded-metal shape, or the like as appropriate.

The common portion 201a and the protrusion 201b which form the negative electrode current collector 201 are formed using the same metal material and are physically continuous. Thus, the negative electrode current collector 201 apparently has a structure like a spiky frog (kenzan) used in the Japanese art of flower arrangement. A connection portion of the common portion 201a and the protrusion 201b is firm; thus, the negative electrode current collector 201 is hardly broken even when stress concentrates by change in volume of the negative electrode active material layer 203.

The protrusions 201b are spaced in a regular manner. Further, the protrusion 201b is extended in the normal direction of the top surface of the common portion 201a. The protrusion 201b preferably has a cylindrical shape, a prismatic shape, or a plate shape. Alternatively, the protrusion 201b may have a shape which is cylindrical on the common portion 201a side and conical or circular truncated conical at the tip. Further alternatively, the protrusion 201b may have a shape which is prismatic on the common portion 201a side and pyramidal or truncated pyramidal at the tip. With the cylindrical protrusion 201b, stress can be efficiently dispersed when the negative electrode active material layer is expanded. With the hexagonal prismatic protrusion 201b, stress at an edge can be reduced and adjacent negative electrode active material layers can efficiently be in contact with each other when the negative electrode active material layer is expanded. With the pillar protrusion 201b, a space between side surfaces of adjacent protrusions 201b facing each other can be filled with the negative electrode active material layer in the case where carrier ions are inserted and the negative electrode active material layers are expanded; thus, the capacity of the negative electrode active material layer and a distance between adjacent protrusions when adjacent negative electrode active material layers are in contact with each other by the expansion can be easily controlled.

Note that the edge of the protrusion 201b may be curved. In FIG. 1A, a cylindrical protrusion is used as the protrusion 201b. Although a side surface of the protrusion 201b in a cross-sectional view is extended straight from the common portion 201a in FIG. 1B, the side surface may be curved. In addition, although the common portion 201a and the protrusion 201b form a right angle at the connection portion thereof in the cross-sectional shape, the connection portion can be curved so that stress concentration in the connection portion of the common portion 201a and the protrusion 201b can be reduced.

The width (diameter) of the protrusion 201b in the cross-sectional shape is greater than or equal to 50 nm and less than or equal to 5 μm. Further, the height of the protrusion 201b is greater than or equal to 1 μm and less than or equal to 100 μm. Thus, the aspect ratio of the protrusion 201b is greater than or equal to 0.2 and less than or equal to 2000. The higher the height of the protrusion 201b is, the larger the area of the negative electrode active material layer 203 which is in contact with the electrolyte is; thus, the amount of carrier ions to be inserted can be increased. In other words, the capacity of the negative electrode active material layer can be increased.

Here, the height of the protrusion 201b means the length of a perpendicular line drawn from the top (or top surface) of the protrusion 201b to the surface of the common portion 201a in the cross-sectional shape in the longitudinal direction of the protrusion portion. Note that since the common portion 201a and the protrusion 201b are formed using the same metal material, the interface between the common portion 201a and the protrusion 201b is not always clear. For this reason, in the connection portion of the common portion 201a and the protrusion 201b in the current collector, a plane which is shared by the common portion 201a and the protrusion 201b is defined as the interface between the common portion 201a and the protrusion 201b. Note that in the case where the surface of the common portion 201a is rough, the surface of the common portion 201a is defined by the position obtained by average surface roughness.

The negative electrode active material layer 203 is formed at least on the side surface of the protrusion 201b. The negative electrode active material layer 203 may be formed on the surface of the common portion 201a; however, distortion is caused when the negative electrode active material layer 203 formed on the side surface of the protrusion 201b is expanded by insertion of carrier ions thereinto. Thus, it is preferable that the negative electrode active material layer 203 be not formed on the surface of the common portion 201a, or that the thickness of the negative electrode active material layer formed on the surface of the common portion 201a be extremely thin.

The negative electrode active material layer 203 may be formed over the top of the protrusion 201b; however, carrier ions are inserted into the negative electrode active material layer 203 formed over the top of the protrusion 201b after adjacent negative electrode active material layers are in contact with each other. As a result, an increase in capacity of the negative electrode active material layer is less likely to be saturated and the negative electrode active material layer keeps expanding, resulting in breakdown of the negative electrode active material layer. For this reason, it is preferable that the negative electrode active material layer 203 be not formed over the top of the protrusion 201b, or that the thickness of the negative electrode active material layer formed over the top of the protrusion 201b be extremely thin.

As a negative electrode active material included in the negative electrode active material layer 203, one or more of silicon, germanium, tin, aluminum, and the like, which can absorb and release carrier ions, may be used. Alternatively, silicon to which an impurity element imparting one conductivity type, such as phosphorus or boron, is added may be used for the negative electrode active material layer 203. Silicon to which an impurity element imparting one conductivity type, such as phosphorus or boron, is added has higher conductivity; thus, the conductivity of the active material layer can be increased.

The negative electrode active material layer 203 can have one of an amorphous structure, a microcrystal structure, a polycrystalline structure, and a single crystal structure, or a combined structure of two or more of the above. In the case where the negative electrode active material is silicon, the conductivity of the negative electrode active material layer can be increased because silicon with high crystallinity generally has high electric conductivity. In contrast, amorphous silicon absorbs more carrier ions than silicon with high crystallinity, so that the charge-discharge capacity of a lithium secondary battery can be increased.

The negative electrode active material layer 203 may also have a structure in which a crystalline region is on an inner side, that is, the protrusion 201b side, and an amorphous region is on an outer side. In this case, higher conductivity can be secured by the crystalline region on the inner side and carrier ions can be absorbed into the amorphous region on the outer side.

The thickness of the negative electrode active material layer 203 is preferably greater than or equal to 50 nm and less than or equal to 5 μm. Note that the thickness of the negative electrode active material layer 203 is a thickness in a direction parallel to the normal direction of the side surface of the protrusion 201b. The height of the protrusion 201b is set to be greater than the thickness of the negative electrode active material layer 203, so that a plane 203a which is parallel to the side surface of the protrusion 201b has a larger region which is exposed to the electrolyte than a plane 203b which intersects the side surface of the protrusion 201b, or which is parallel to the top surface of the protrusion 201b; thus, the amount of carrier ions to be inserted and the capacity of the negative electrode active material layer can be increased.

Next, a negative electrode 215, in which carrier ions are inserted into the negative electrode active material layer 203 illustrated in FIGS. 1A and 1B from the positive electrode, the negative electrode active material layer is expanded, and thus adjacent negative electrode active material layers are in contact with each other, will be described with reference to FIGS. 2A to 2C.

FIG. 2A is a top view of the negative electrode 215 and FIG. 2B is a cross-sectional view taken along dashed-dotted line A-B in FIG. 2A. In FIG. 2A, the negative electrode active material layer 203 before a battery is charged, which is illustrated in FIG. 1A, is shown by a dashed line. The negative electrode active material layer 203 is expanded by insertion of carrier ions from the positive electrode and thus, adjacent negative electrode active material layers 213 are in contact with each other.

In the negative electrode 215 illustrated in FIG. 2B, the negative electrode active material layer 213 formed on the side surface of the protrusion 201b is expanded by insertion of carrier ions from the positive electrode. Further, adjacent negative electrode active material layers 213 each formed on the side surface of the protrusion 201b are in contact with each other.

Note that as illustrated in FIG. 2C, a surface coating film (hereinafter referred to as a solid electrolyte interface (SEI) film) shown by a dashed line 217 may be formed between adjacent negative electrode active material layers 213. Since the SEI film is permeable to carrier ions but is not permeable to electrons, electrochemical reductive decomposition of an electrolyte can be suppressed and the electrolyte can be stabilized.

In this specification, the case where adjacent negative electrode active material layers are in contact with each other includes both of the case where the negative electrode active material layers are directly in contact with each other and the case where the negative electrode active material layers are adjoining each other with an SEI film provided therebetween.

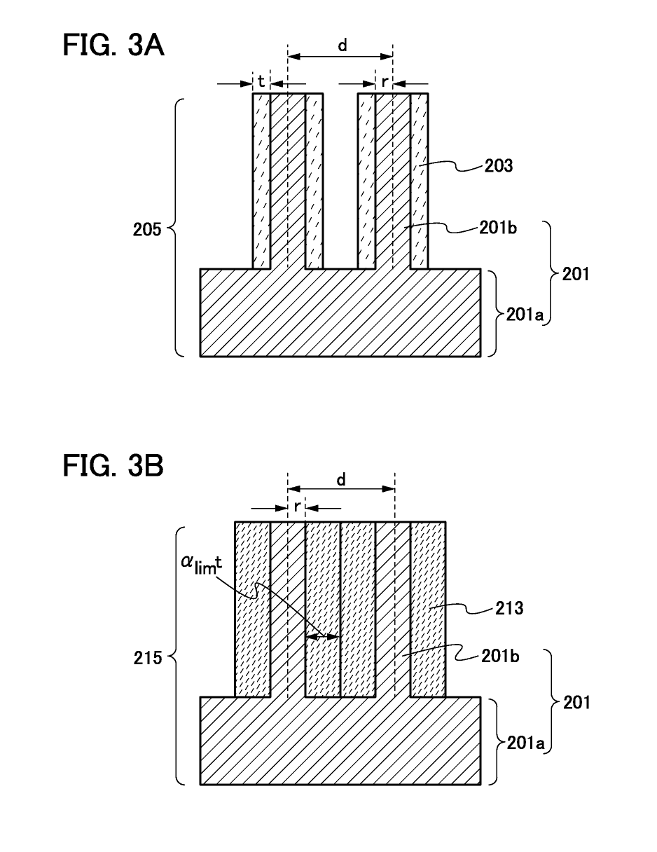

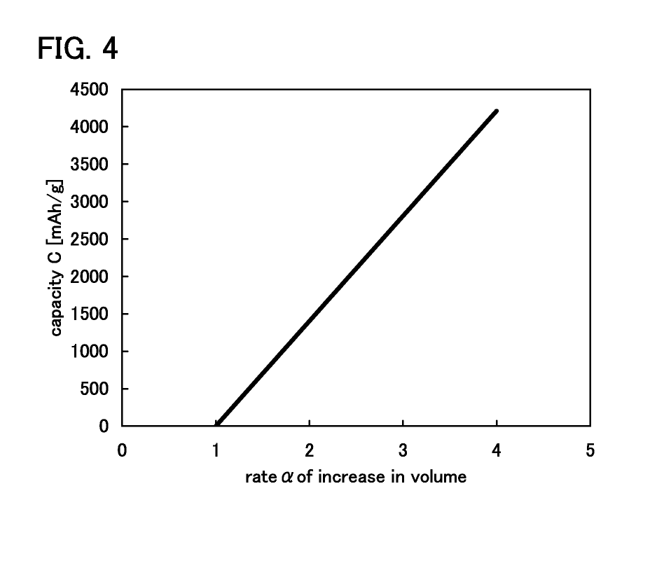

Here, a relation between the capacity of the negative electrode active material layer and a distance between adjacent protrusions 201b will be described with reference to FIGS. 3A and 3B and FIG. 4.

FIG. 3A is an enlarged cross-sectional view of part of the negative electrode 205 illustrated in FIG. 1B, that is, the negative electrode 205 in which carrier ions are not yet inserted into the negative electrode active material layer 203 (or the negative electrode 205 before a battery is charged). FIG. 3B is an enlarged cross-sectional view of part of the negative electrode 215 illustrated in FIG. 2B, that is, the negative electrode 215 in which adjacent negative electrode active material layers 213 are in contact with each other.

In FIGS. 3A and 3B, r, t, and d represent a half of the width of the protrusion 201b of the negative electrode current collector 201 (in the case where the protrusion is a cylinder, a radius thereof), the thickness of the negative electrode active material layer 203, and the distance between adjacent protrusions, respectively.

In this embodiment, the capacity of the negative electrode active material layer into which the maximum amount of carrier ions are inserted is expressed by the theoretical capacity C, and the rate of increase in volume of the negative electrode active material layer at this time is expressed by the maximum rate αₘ of increase in volume. In addition, the capacity of the negative electrode active material layer in the case where adjacent negative electrode active material layers 213 are in contact with each other as illustrated in FIG. 3B is expressed by Cₗ (Cₗ<Cᵢ), and the rate of increase in volume of the negative electrode active material layer at this time is the limited rate αₗᵢₘ of increase in volume. The thickness of the negative electrode active material layer 213 is expressed by αₗᵢₘt.

In the case where the maximum amount of carrier ions are inserted into the negative electrode active material layer, that is, the capacity of the negative electrode active material layer reaches the theoretical capacity, the negative electrode active material layer might be expanded to the maximum size and distortion might occur, which might break the negative electrode active material layer. On the other hand, in the case where the amount of carrier ions to be inserted into the negative electrode active material layer is limited, the expansion of the negative electrode active material layer can be limited. Thus, even if adjacent negative electrode active material layers are in contact with each other, distortion of the negative electrode active material layer is small, so that breakdown of the negative electrode active material layer can be prevented. Further, in the case where adjacent negative electrode active material layers are in contact with each other, the area of the negative electrode active material layer which is exposed to the electrolyte is decreased, resulting in a decrease in the amount of carrier ions to be inserted into the negative electrode active material layer; thus, the resistance of the negative electrode active material layer is increased. As a result, an increase in capacity of the negative electrode active material layer is saturated. At this time, a voltage of the lithium secondary battery is increased owing to the increase in the resistance, whereby charge of the lithium secondary battery can be stopped by determining a change in the voltage with the use of an external circuit. In other words, charge can be stopped when adjacent negative electrode active material layers are in contact with each other.

Even when the thicknesses t of the negative electrode active material layers vary at the beginning of insertion of carrier ions because of slight variation in widths or the heights of the protrusions 201b, the area of the negative electrode active material layer which is exposed to the electrolyte is decreased when adjacent negative electrode active material layers are in contact with each other. Thus, the resistance is increased in a region 219a whose area where the negative electrode active material layer 213 is exposed to the electrolyte is small (see FIG. 2A). As a result, a larger amount of carrier ions is inserted into a region 219b whose area where the negative electrode active material layer is exposed to the electrolyte is large (see FIG. 2A). When carrier ions are inserted into a region with a large cross section, the negative electrode active material layer is expanded and the contact area between adjacent negative electrode active material layers is increased; thus, the area of the negative electrode active material layer which is exposed to the electrolyte is decreased. As a result, in the negative electrode active material layer, a region into which a larger amount of carrier ions is inserted is gradually shifted, so that variation in the amount of carrier ions to be inserted in a plane of the negative electrode can be reduced. Thus, the uniformity of an electrode reaction can be increased and deterioration of an electrode can be reduced.

That is, this embodiment includes the negative electrode current collector including the protrusions, and the distance between adjacent protrusions is controlled so that adjacent negative electrode active material layers are in contact with each other when the capacity thereof reaches a predetermined capacity to control the amount of carrier ions to be inserted into the negative electrode active material layer; thus, breakdown of the negative electrode active material layer can be prevented. Further, variation in the amount of carrier ions to be inserted in a plane of the negative electrode can be reduced and thus, the uniformity of an electrode reaction can be increased and deterioration of an electrode can be reduced.

Here, a relation between the capacity of a negative electrode active material layer and a distance between adjacent protrusions will be described below.

First, the rate of increase in volume of the negative electrode active material layer is represented by α, and the maximum rate of increase in volume of the negative electrode active material layer is represented by αₘ. The rate α of increase in volume and the capacity C of the negative electrode active material layer are assumed to have a relation in Formula 2.

$$C = \frac{{C}_{i}}{( {α}_{m} - 1 )} \times α - \frac{{C}_{i}}{( {α}_{m} - 1 )} \qquad [ FORMULA 2 ]$$

Formula 3 is a deformation of Formula 2.

$$C = \frac{{C}_{i}}{( {α}_{m} - 1 )} \times ( α - 1 ) \qquad [ FORMULA 3 ]$$

From Formula 3, in the case where the negative electrode active material layer is formed using silicon, the maximum rate αₘ of increase in volume becomes 4 and the theoretical capacity Cₗ becomes 4212 mAh/g; accordingly, a relation between the rate α of increase in volume and the capacity C of the negative electrode active material layer can be represented by a graph in FIG. 4. In FIG. 4, the horizontal axis represents the rate α of increase in volume and the vertical axis represents the C of the negative electrode active material layer. As shown in FIG. 4, the rate α of increase in volume and the capacity C have a linear relation. Note that the maximum rate αₘ of increase in volume and the theoretical capacity Cᵢ of each material that can be used as the negative electrode active material are as follows: αₘ and Cᵢ of aluminum are 1.9 and 993 mAh/g, respectively; αₘ and C, of germanium are 3.7 and 1624 mAh/g, respectively, and αₘ and Cᵢ of tin are 3.6 and 994 mAh/g, respectively.

Then, Formula 4 is a formula for the rate α of increase in volume, and is a deformation of Formula 3.

$$α = \frac{{α}_{m} - 1}{{C}_{i}} \times C + 1 \qquad [ FORMULA 4 ]$$

Here, the height of the protrusion is assumed to be much greater than the thickness of the negative electrode active material layer and a change in volume of the negative electrode active material layer is assumed to be sufficiently dominant in the thickness direction, that is, in the normal direction of the side surface of the protrusion. In FIG. 3A, a half of the width of the protrusion 201b before the battery is charged is represented by r and the thickness of the negative electrode active material layer 203 is represented by t. Further, the space between adjacent protrusions 201b is represented by d.

When the capacity of the negative electrode active material layer in the case where adjacent negative electrode active material layers 213 each formed on the side surface of the protrusion are in contact with each other by insertion of carrier ions into the negative electrode active material layer as illustrated in FIG. 3B is Cᵢ, and the rate of increase in volume at this time is the limited rate αₗᵢₘ of increase in volume, the limited rate αₗᵢₘ of increase in volume can be expressed by Formula 5.

$${α}_{lim} = \frac{( {α}_{m} - 1 )}{{C}_{i}} \times {C}_{l} + 1 \qquad [ FORMULA 5 ]$$

The distance d between adjacent protrusions in the case where adjacent negative electrode active material layers 213 each formed on the side surface of the protrusion are in contact with each other as illustrated in FIG. 3B is expressed by Formula 6. Note that the thickness of the negative electrode active material layer 213 at this time is represented by αₗᵢₘt.

d=2×(r+αₗᵢₘt) [FORMULA 6]

From Formula 5 and Formula 6, the distance between adjacent protrusions can be expressed by Formula 7.

$$d = 2 \times \{ r + t \times [ \frac{( {α}_{m} - 1 )}{{C}_{i}} \times {C}_{l} + 1 ] \} \qquad [ FORMULA 7 ]$$

According to Formula 7, controlling the distance between the protrusions so that adjacent negative electrode active material layers are in contact with each other enables the amount of carrier ions to be inserted into the negative electrode active material layer to be controlled, so that breakdown of the negative electrode active material layer can be prevented.

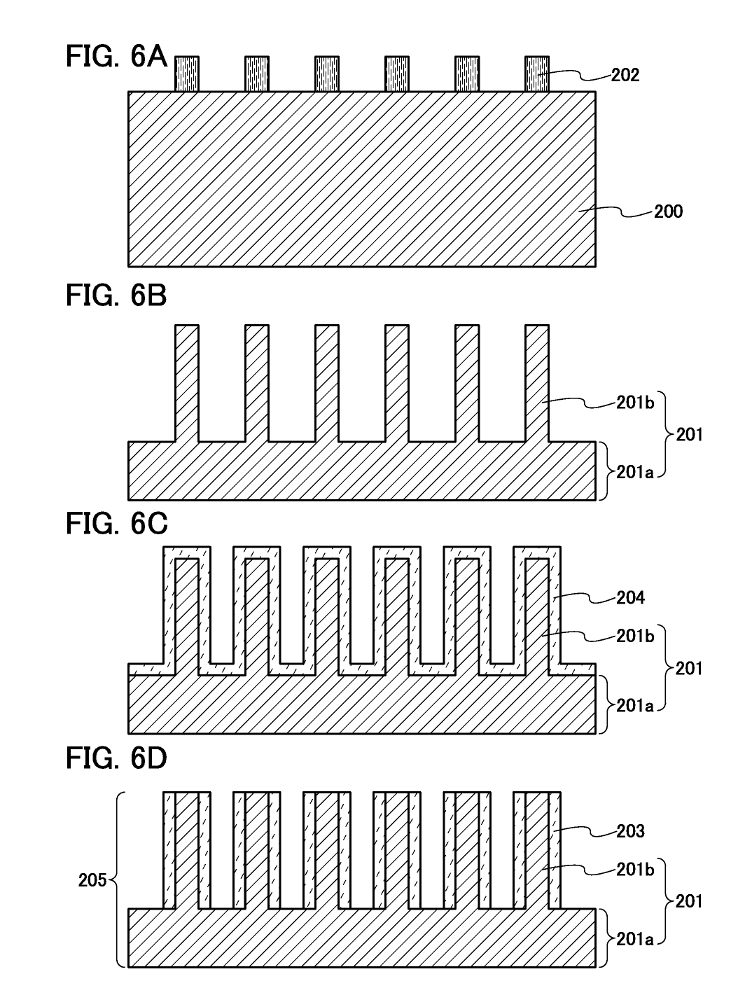

Next, a method for forming the negative electrode 205 illustrated in FIG. 1B will be described with reference to FIGS. 6A to 6D.

As illustrated in FIG. 6A, masks 202 are formed over a conductive material 200 which is to be the negative electrode current collector. The masks 202 are used for etching of part of the conductive material 200 to form the protrusion.

Any of the materials given for the negative electrode current collector 201 can be used as appropriate for the conductive material 200 which is to be the negative electrode current collector. Further, any of the shapes given for the negative electrode current collector 201 can be applied as appropriate to the conductive material 200 which is to be the negative electrode current collector. Note that in the case where the conductive material 200 which is to be the negative electrode current collector has a net-like shape or the like which has an opening portion, the masks 202 are formed on a surface of the conductive material except the opening portion.

The masks 202 can be formed by photolithography, an ink-jet method, a printing method, nanoimprint lithography or the like.

As nanoimprint lithography, thermal nanoimprint lithography or photo nanoimprint lithography can be used.

In thermal nanoimprint lithography, a thermoplastic resin is provided over the conductive material 200 which is to be the negative electrode current collector, the thermoplastic resin is heated to be softened, and then a mold is pressed against the thermoplastic resin, whereby the thermoplastic resin is deformed. The deformed thermosetting resin is cooled and cured. After that, the mold is detached, so that the masks 202 can be formed.

In photo nanoimprint lithography, a photocurable resin is provided over the conductive material 200 which is to be the negative electrode current collector, and then the photocurable resin is irradiated with ultraviolet rays while a mold is pressed against the photocurable resin to deform the photocurable resin, whereby the photocurable resin is cured. After that, the mold is detached, so that the masks 202 can be formed.

An expensive light exposure apparatus and a photomask are not used in nanoimprint lithography, so that a negative electrode can be formed at low cost. In addition, a sheet-like material can be used as the conductive material 200 which is to be the negative electrode current collector and a roll-to-roll method can be employed; thus, nanoimprint lithography is suitable for mass production of negative electrodes.

Then, the conductive material 200 which is to be the negative electrode current collector is selectively etched with the use of the masks 202 and then the masks 202 are removed, so that the negative electrode current collector 201 having the common portion 201a and the plurality of protrusions 201b as illustrated in FIG. 6B is formed. As a method for etching the conductive material 200 which is to be the negative electrode current collector, a dry etching method or a wet etching method can be used as appropriate. In particular, in the case where a protrusion with high aspect ratio is formed, a dry etching method is preferably used.

For example, the conductive material 200 which is to be the negative electrode current collector (here, a titanium film) is etched using a mixed etching gas of BCl₃ and Cl₂ with an inductively coupled plasma (ICP) apparatus, whereby the negative electrode current collector 201 including the common portion 201a and the plurality of protrusions 201b can be formed. The flow ratio of the etching gas may be adjusted as appropriate. For example, the flow ratio of BCl₃ to Cl₂ can be set to 3:1.

The protrusion 201b can be formed into any shape by adjusting etching conditions such as an initial shape of the photoresist pattern, etching time, an etching gas, applied bias, pressure in a chamber, and the substrate temperature as appropriate.

The remaining conductive material 200, which is to be the negative electrode current collector, other than the formed protrusions 201b is the common portion 201a. The surface of the common portion 201a may be flat. However, in the case where the surface becomes rough because of the etching step, the surface area of the negative electrode active material layer which is formed in a later step is increased, which contributes to an increase in battery capacity.

The current collector material is etched with the use of the masks 202 as described in this embodiment, whereby the plurality of protrusions extended in the normal direction of the surface of the common portion 201a can be formed. In addition, a plurality of protrusions which have substantially the same shape and are uniform can be formed.

Note that the negative electrode current collector 201 illustrated in FIG. 6B is formed by pressing the conductive material instead of by performing steps in FIGS. 6A and 6B, whereby the number of steps for forming the negative electrode can be reduced and the negative electrode can be formed at low cost.

Next, a layer 204 which is to be the negative electrode active material layer is formed over the negative electrode current collector 201 as illustrated in FIG. 6C.

The layer 204 which is to be the negative electrode active material layer is formed by a CVD method, a sputtering method, an evaporation method, or the like as appropriate. In the case where the layer 204 which is to be the negative electrode active material layer is formed using a silicon layer, a plasma chemical vapor deposition (CVD) method or a thermal CVD method can be employed. The layer 204 which is to be the negative electrode active material layer can be formed using any of the materials given for the negative electrode active material layer 203 as appropriate.

Then, the negative electrode 205 in which the negative electrode active material layer 203 is provided only on the side surface of the protrusion 201b as illustrated in FIG. 6D can be formed in the following manner: anisotropic etching is performed on the layer 204 which is to be the negative electrode active material layer with an ICP apparatus or the like to remove part of the layer 204 which is to be the negative electrode active material layer. Here, the layers 204 formed over the surface of the common portion 201a and the top of the protrusion 201b are etched, whereby the negative electrode 205 in which the negative electrode active material layer 203 is provided only on the side surface of the protrusion 201b can be formed.

This embodiment can be implemented in combination with any of the other embodiments as appropriate.

### Embodiment 2

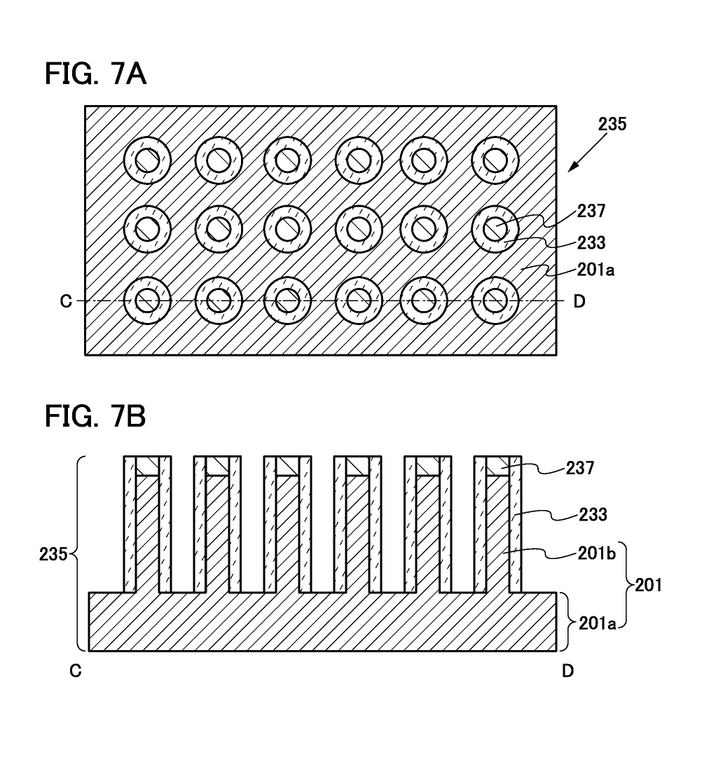

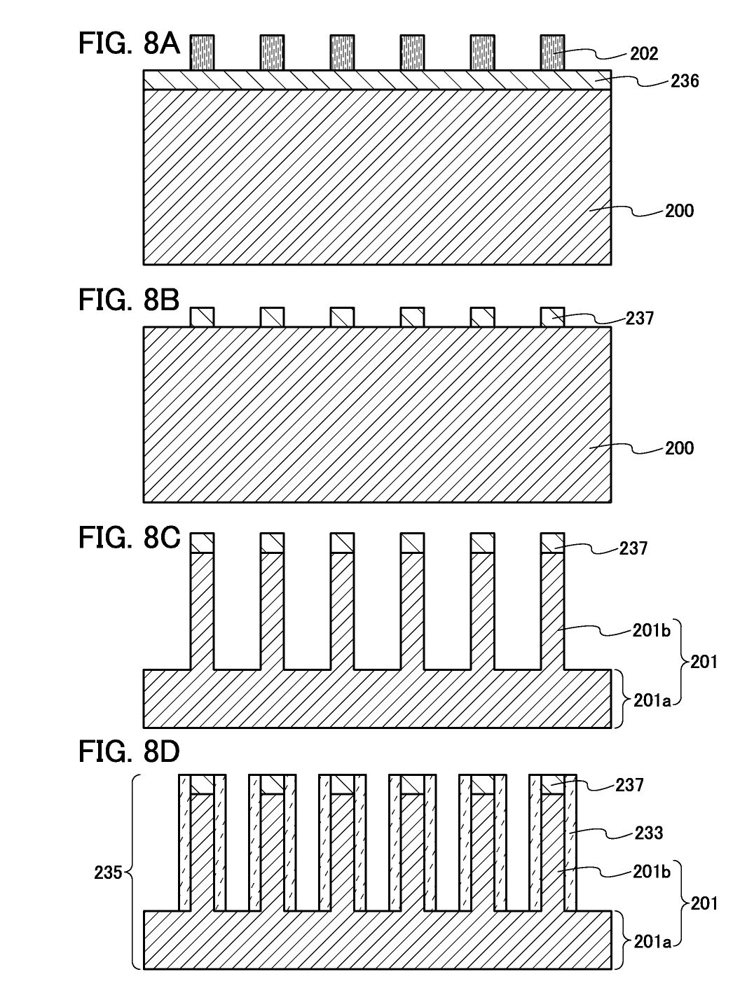

In this embodiment, the structure of a negative electrode which can be used for the power storage device described in Embodiment 1 and a formation method thereof will be described with reference to FIGS. 7A and 7B and FIGS. 8A to 8D. The negative electrode described in this embodiment includes protective layers over the tops of the plurality of protrusions.

FIG. 7A is a top view of a negative electrode 235 described in this embodiment and FIG. 7B is a cross-sectional view taken along dashed-dotted line C-D in FIG. 7A.

The negative electrode 235 includes the negative electrode current collector 201 having the common portion 201a and the plurality of protrusions 201b protruding from the common portion 201a, protective layers 237 formed over the tops of the plurality of protrusions 201b, and a negative electrode active material layer 233 formed on side surfaces of the plurality of protrusions 201b and the protective layer 237. Further, the plurality of protrusions 201b are arranged so that adjacent negative electrode active material layers 233 are in contact with each other when the capacity of the negative electrode active material layer is lower than the theoretical capacity of the negative electrode active material layer.

As the protective layer 237, a conductive layer or an insulating layer formed using a material whose etching rate is lower than that of a material for the negative electrode current collector 201 is preferably used. The protective layer 237 is formed using a material that is less likely to be etched than a material for the negative electrode current collector 201, so that the protective layer 237 serves as a hard mask when the plurality of protrusions are formed by etching; thus, variation in heights between the plurality of protrusions can be reduced. As an insulating layer that can be used for the protective layer 237, a silicon oxide layer, a silicon nitride layer, a silicon oxynitride layer, an aluminum oxide layer, and the like can be given. Alternatively, in the case where the protective layer 237 is formed using a conductive layer, the protective layer 237 can serve as part of the current collector.

The thickness of the protective layer 237 is preferably greater than or equal to 100 nm and less than or equal to 10 μm.

Next, a method for forming the negative electrode 235 will be described with reference to FIGS. 8A to 8D.

As illustrated in FIG. 8A, a protective layer 236 is formed over the conductive material 200 which is to be the negative electrode current collector and in a manner similar to that in Embodiment 1, the masks 202 are formed over the protective layer 236.

Any of the materials given for the negative electrode current collector 201 can be used as appropriate for the conductive material 200 which is to be the negative electrode current collector. Further, any of the shapes given for the negative electrode current collector 201 can be applied as appropriate to the conductive material 200 which is to be the negative electrode current collector.

The protective layer 236 can be formed by a CVD method, a sputtering method, an evaporation method, a plating method, or the like. The protective layer 236 can be formed using any of the materials given for the protective layer 237 as appropriate.

Then, the protective layer 236 is selectively etched with the use of the masks 202 and then the masks 202 are removed, so that the protective layer 237 is formed over the conductive material 200 which is to be the negative electrode current collector as illustrated in FIG. 8B.

As a method for etching the protective layer 236, a dry etching method or a wet etching method can be used as appropriate.

Subsequently, the conductive material 200 which is to be the negative electrode current collector is selectively etched in a manner similar to that in Embodiment 1 with the use of the protective layer 237 as a mask to form the negative electrode current collector 201 having the common portion 201a and the plurality of protrusions 201b, and the protective layer 237 over the top of the protrusion 201b as illustrated in FIG. 8C. The protective layer 237 is formed using a material which is less likely to be etched than the conductive material 200 which is to be the negative electrode current collector. Thus, even in the case where the protrusion 201b is tall, in other words, in the case where the etching time of the conductive material 200 which is to be the negative electrode current collector is long, the protective layer 237 remains and serves as a mask, which enables variation in heights of the protrusions 201b to be reduced.

Note that although the masks 202 are removed and the conductive material 200 which is to be the negative electrode current collector is etched with the use of the protective layer 237 as a mask here, the conductive material 200 which is to be the negative electrode current collector may be etched with the use of the masks 202 and the protective layer 237 and then the masks 202 may be removed.

After that, a layer which is to be the negative electrode active material layer is formed over the negative electrode current collector 201 and the protective layer 237 in a manner similar to that in Embodiment 1 and then part of the layer is selectively etched, so that the negative electrode active material layer 233 can be formed only on the side surfaces of the negative electrode current collector 201 and the protective layer 237 as illustrated in FIG. 8D.

Through the above steps, the negative electrode 235 can be formed.

This embodiment can be implemented in combination with any of the other embodiments as appropriate.

### Embodiment 3

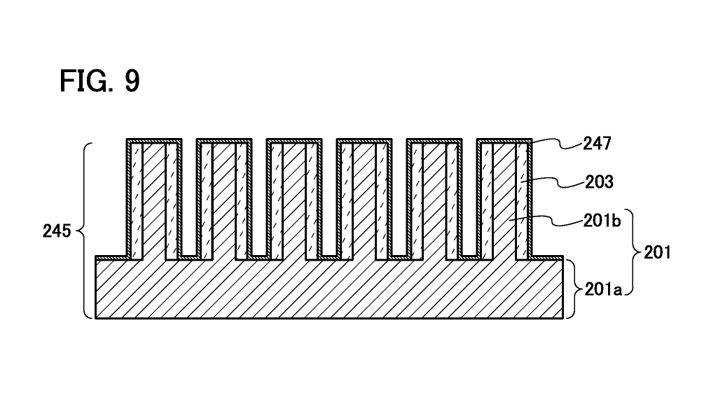

In this embodiment, a mode in which graphene is provided over the negative electrode active material layer of the negative electrode described in Embodiment 1 will be described with reference to FIG. 9. Note that although description is made using Embodiment 1 in this embodiment, Embodiment 2 can also be used.

Graphene refers to a sheet of one atomic layer of carbon molecules having double bonds. Graphene is chemically stable and has favorable electric characteristics.

FIG. 9 illustrates an example in which graphene 247 is applied to the negative electrode described in Embodiment 1. The graphene 247 is formed so as to cover the surface of the common portion 201a of the negative electrode current collector 201, the top of the protrusion 201b of the negative electrode current collector 201, and the negative electrode active material layer 203. The graphene 247 may entirely or partially cover the surface of the common portion 201a of the negative electrode current collector 201, the top of the protrusion 201b of the negative electrode current collector 201, and the negative electrode active material layer 203. For example, the graphene 247 may only cover the negative electrode active material layer 203. Alternatively, the surface of the negative electrode active material layer 203 may be covered without a space or with spaces in places in a spot-like manner.

The graphene 247 functions as a conductive additive. The graphene 247 also functions as an active material in some cases.

The graphene 247 includes a single-layer graphene and a multilayer graphene in its category. The graphene 247 has a sheet-like shape with a length of several micrometers.

The single-layer graphene refers to a sheet of one atomic layer of carbon molecules having double bonds and is very thin. In addition, six-membered rings each composed of carbon atoms are connected in the planar direction, and poly-membered rings each formed when a carbon bond in part of a six-membered ring is broken, such as a seven-membered ring, an eight-membered ring, a nine-membered ring, and a ten-membered ring, are partly formed.

A poly-membered ring is composed of a carbon atom and an oxygen atom in some cases. Alternatively, an oxygen atom is bonded to a carbon atom in a poly-membered ring in some cases. In the case where graphene contains oxygen, a carbon bond in part of a six-membered ring is broken, and an oxygen atom is bonded to a carbon atom whose bond is broken, whereby the poly-membered ring is formed. Thus, an opening serving as a path through which carrier ions can transfer is included in the bond between the carbon atom and the oxygen atom. That is, as the proportion of oxygen atoms included in a graphene is higher, the proportion of openings each serving as a path through which carrier ions can transfer is increased.

Note that in the case where the graphene 247 contains oxygen, the proportion of the oxygen is higher than or equal to 2 atomic % and lower than or equal to 11 atomic %, preferably higher than or equal to 3 atomic % and lower than or equal to 10 atomic % of the total. As the proportion of oxygen is lower, the conductivity of the graphene can be increased. As the proportion of oxygen becomes higher, more openings serving as paths of carrier ions can be formed in the graphene.

In the case where the graphene 247 is multilayer graphene, the graphene 247 includes a plurality of sheets of single-layer graphene, typically, 2 to 100 sheets of single-layer graphene and is thus very thin. When the single-layer graphene contains oxygen, the interlayer distance between the sheets of graphene is greater than 0.34 nm and less than or equal to 0.5 nm, preferably greater than or equal to 0.38 nm and less than or equal to 0.42 nm, further preferably greater than or equal to 0.39 nm and less than or equal to 0.41 nm. In general graphite, the interlayer distance between the sheets of single-layer graphene is 0.34 nm. Since the interlayer distance between the sheets of the graphene 247 is longer than that in general graphite, carrier ions can easily transfer in the direction parallel to a surface of the single-layer graphene. In addition, the graphene 247 contains oxygen and includes single-layer graphene or multilayer graphene in which a poly-membered ring is formed and thus includes openings in places. Thus, in the case where the graphene 247 is multilayer graphene, carrier ions can transfer in the direction parallel to a surface of the single-layer graphene, i.e., through a space between the sheets of single-layer graphene, and in the direction perpendicular to a surface of the graphene, i.e., through an opening formed in each single-layer graphene.

When the surface of the negative electrode active material layer 203 is exposed to an electrolyte in a lithium secondary battery, the electrolyte and an active material react with each other, so that an SEI film is formed on a surface of the active material. As the SEI film becomes thicker, carrier ions are hardly inserted into the negative electrode active material layer, which causes problems of a reduction in conductivity of carrier ions between the negative electrode active material layer and the electrolyte, a waste of the electrolyte, and the like. However, with the graphene 247 covering the negative electrode active material layer 203, an increase in thickness of the SEI film can be suppressed; thus, a reduction in conductivity of carrier ions and a waste of the electrolyte can be suppressed.

Graphene has high conductivity; thus, covering the negative electrode active material layer 203 with the graphene 247 enables transfer of electrons in graphene at sufficiently high speed. As a result, the conductivity of carrier ions can be increased, reaction between silicon that is a negative electrode active material and carrier ions can be increased, and carrier ions can be easily absorbed into the negative electrode active material layer. Thus, a lithium secondary battery including the negative electrode can perform charge and discharge at high speed.

Note that in the case where the negative electrode active material layer 203 is formed using silicon, a silicon oxide layer may be provided between the negative electrode active material layer 203 and the graphene 247. By provision of the silicon oxide layer over the negative electrode active material layer 203, carrier ions are inserted into silicon oxide in charging of the lithium secondary battery. As a result, a silicate compound, for example, Li₄SiO₄ is formed. In the case where carrier ions are alkali metal ions other than lithium ions, alkaline-earth metal ions, beryllium ions, or magnesium ions, alkali metal silicate such as Nα₄SiO₄, or K₄SiO₄; alkaline earth metal silicate such as Ca₂SiO₄, Sr₂SiO₄, or Bα₂SiO₄; Be₂SiO₄; or Mg₂SiO₄ is formed. Such a silicate compound serves as a path through which carrier ions transfer. By provision of the silicon oxide layer, expansion of the negative electrode active material layer 203 can be suppressed. Accordingly, breakdown of the negative electrode active material layer 203 can be suppressed while the capacity of the negative electrode active material layer 203 is maintained. Note that in discharging after charging, not all metal ions serving as carrier ions are released from the silicate compound formed in the silicon oxide layer and part of the metal ions remain, so that the silicon oxide layer is a mixture layer of silicon oxide and the silicate compound.

The thickness of the silicon oxide layer is preferably greater than or equal to 2 nm and less than or equal to 10 nm. With the thickness of the silicon oxide layer being greater than or equal to 2 nm, expansion of the negative electrode active material layer 203 due to charge-discharge can be relieved. In addition, with the thickness of the silicon oxide layer being less than or equal to 10 nm, carrier ions can transfer easily, which can prevent a reduction in capacity of the negative electrode active material layer 203. By provision of the silicon oxide layer over the negative electrode active material layer 203, expansion and contraction of the negative electrode active material layer 203 due to charge-discharge can be relieved, so that the negative electrode active material layer 203 can be prevented from being broken.

Next, a method for forming a negative electrode 245 will be described.

As described in Embodiment 1, the negative electrode 245 illustrated in FIG. 9 can be formed in such a manner that the negative electrode active material layer 203 is formed over the negative electrode current collector 201 and then the graphene 247 is formed at least over the negative electrode active material layer 203.

As a method for forming the graphene 247, there are a gas phase method and a liquid phase method. In the gas phase method, nickel, iron, gold, copper, or an alloy containing such a metal is formed as a nucleus over the negative electrode active material layer 203, and then, graphene is grown from the nucleus in an atmosphere containing hydrocarbon such as methane or acetylene. In the liquid phase method, graphene oxide is provided on the surface of the negative electrode active material layer 203 using a dispersion liquid containing graphene oxide, and then, the graphene oxide is reduced to form graphene.

To form the dispersion liquid containing graphene oxide, a method in which graphene oxides are dispersed in a solvent; a method in which after graphite is oxidized in a solvent, graphite oxide is separated into graphene oxide to form a dispersion liquid containing graphene oxide; or the like can be employed.

To form graphite oxide, a method in which sulfuric acid, nitric acid, and potassium chlorate are used as an oxidizer; a method in which sulfuric acid and potassium permanganate are used as an oxidizer; a method in which potassium chlorate and fuming nitric acid are used as an oxidizer; or the like can be employed as appropriate.

Note that graphene oxide includes an epoxy group, a carbonyl group, a carboxyl group, a hydroxyl group, or the like. Such a substituent has high polarity, so that graphene oxides are likely to disperse in a liquid having a polarity. Accordingly, graphene oxides disperse uniformly in a liquid having a polarity.

As a method for providing graphene oxide over the negative electrode active material layer 203 using the dispersion liquid containing graphene oxide, a coating method, a spin coating method, a dipping method, a spray method, an electrophoresis method, or the like may be employed. Alternatively, these methods may be combined as appropriate.

In a method for reducing graphene oxide provided over the negative electrode active material layer 203, heating is performed at higher than or equal to 150° C., preferably higher than or equal to 300° C. and lower than or equal to the temperature at which the negative electrode active material layer 203 can withstand, in a vacuum, an atmosphere of an inert gas (e.g., nitrogen or a rare gas), or the like. By being heated at a higher temperature and for a longer time, graphene oxide is reduced to a higher extent so that graphene with high purity (i.e., with a low concentration of elements other than carbon) can be obtained. The temperature for heating has to be determined in consideration of reactivity between the graphene oxide and the object. Note that graphene oxide is known to be reduced at 150° C. In addition, there is also a method in which graphene oxide is soaked in a reducing solution to be reduced.

Depending on the temperature of reduction treatment, the conductivity of the graphene changes as described above; the same can also apply to its flexibility, strength, and the like. The temperature of the reduction treatment may be determined in accordance with the required conductivity, flexibility, strength, and the like.

Through the above reduction treatment, the formed graphene oxide becomes graphene. At this time, adjacent sheets of graphene are bonded to each other to form a larger net-like or sheet-like network. Further, through the reduction treatment, openings are formed in the graphene owing to the release of oxygen. Furthermore, the graphene overlap with each other in parallel to a surface of a substrate. As a result, the graphene in which carrier ions can transfer between sheets and in the openings is formed.

This embodiment can be implemented in combination with any of the other embodiments as appropriate.

### Embodiment 4

In this embodiment, structures and methods for forming components of a lithium secondary battery other than a negative electrode will be described.

First, a positive electrode and a formation method thereof will be described.

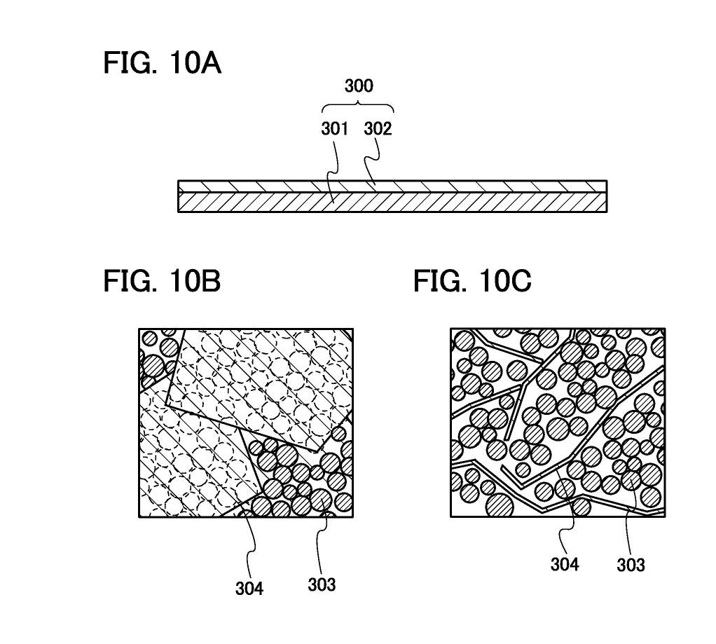

FIG. 10A is a cross-sectional view of a positive electrode 300. In the positive electrode 300, a positive electrode active material layer 302 is formed over a positive electrode current collector 301.

The positive electrode current collector 301 can be formed using a material having high conductivity, for example, a metal such as stainless steel, gold, platinum, zinc, iron, copper, aluminum, or titanium, or an alloy thereof. Note that the positive electrode current collector 301 can be formed using an aluminum alloy to which an element which improves heat resistance, such as silicon, titanium, neodymium, scandium, or molybdenum, is added. Alternatively, the positive electrode current collector 301 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, and nickel. The positive electrode current collector 301 can have a foil-like shape, a plate-like shape (sheet-like shape), a net-like shape, a punching-metal shape, an expanded-metal shape, or the like as appropriate.

The positive electrode active material layer 302 can be formed using a compound such as LiFeO₂, LiCoO₂, LiNiO₂, LiMn₂O₄, V₂O₅, Cr₂O₅, or MnO₂ as a material.

Alternatively, an olivine-type lithium-containing composite oxide (a general formula LiMPO₄ (M is one or more of Fe(II), Mn(II), Co(II), and Ni(II))) can be used. Typical examples of the general formula LiMPO₄ which can be used as a material are lithium-containing composite oxides such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNᵢaMn_{b}PO₄ (a+b≦1, 0<a<1, and 0<b<1), LiFe_{c}Ni_{d}CoₑPO₄, LiFe_{c}Ni_{d}MnₑPO₄, LiNiₑCo_{d}MnₑPO₄ (c+d+e≦1, 0<c<1, 0<d<1, and 0<e<1), and LiFeᵢNi_{g}CoₕMnᵢPO₄ (f+g+h+i≦1, 0<f<1, 0<g<1, 0<h<1, and 0<i<1).

Further alternatively, a lithium-containing composite oxide such as a general formula Li₂MSiO₄ (M is one or more of Fe(II), Mn(II), Co(II), and Ni(II)) can be used. Typical examples of the general formula Li₂MSiO₄ which can be used as a material are lithium-containing composite oxides such as Li₂FeSiO₄, Li₂NiSiO₄, Li₂CoSiO₄, Li₂MnSiO₄, Li₂FeₖNiₗSiO₄, Li₂FeₖCoₗSiO₄, Li₂FeₖMnₗSiO₄, Li₂NiₖCOₗSiO₄, Li₂NiₖMnᵢSiO₄ (k+l≦1, 0<k<1, and 0<l<1), Li₂FeₘNiₙCo_{q}SiO₄, Li₂FeₘNiₙMn_{q}SiO₄, Li₂NiₘCoₙMn_{q}SiO₄ (m+n+q≦1, 0<m<1, 0<n<1, and 0<q<1), and Li₂FeᵣNiₛCoₜMnᵤSiO₄ (r+s+t+u≦1, 0<r<1, 0<s<1, 0<t<1, and 0<u<1).

In the case where carrier ions are alkali metal ions other than lithium ions, alkaline-earth metal ions, beryllium ions, or magnesium ions, the following may be used for the positive electrode active material layer 302: a compound or a composite oxide which is obtained by substituting an alkali metal (e.g., sodium or potassium), an alkaline-earth metal (e.g., calcium, strontium, or barium), beryllium, or magnesium for lithium in the lithium compound or the lithium-containing composite oxide.

The positive electrode active material layer 302 is not necessarily in direct contact with the top surface of the positive electrode current collector 301. Between the positive electrode current collector 301 and the positive electrode active material layer 302, any of the following functional layers may be formed using a conductive material such as metal: an adhesive layer for the purpose of improving adhesiveness between the positive electrode current collector 301 and the positive electrode active material layer 302, a planarization layer for reducing unevenness of the surface of the positive electrode current collector 301, a heat radiation layer for radiating heat, and a stress relaxation layer for relieving stress of the positive electrode current collector 301 or the positive electrode active material layer 302.

FIG. 10B is a plan view of the positive electrode active material layer 302. The positive electrode active material layer 302 contains positive electrode active materials 303 which are particles capable of absorbing and releasing carrier ions, and graphene 304 which cover a plurality of positive electrode active materials 303 and at least partly surround the plurality of positive electrode active materials 303. The different sheets of graphene 304 cover surfaces of the plurality of positive electrode active materials 303. The positive electrode active materials 303 may be partly exposed.

The size of the particle of the positive electrode active material 303 is preferably greater than or equal to 20 nm and less than or equal to 100 nm. Note that the size of the particle of the positive electrode active material 303 is preferably small because electrons transfer in the positive electrode active materials 303.

Sufficient characteristics can be obtained even when the surface of the positive electrode active material 303 is not covered with a graphite layer; however, it is preferable to use both the graphene and the positive electrode active material covered with a graphite layer because carriers transfer hopping between the positive electrode active materials, so that current flows.

FIG. 10C is a cross-sectional view of part of the positive electrode active material layer 302 in FIG. 10B. The positive electrode active material layer 302 contains the positive electrode active materials 303 and the graphene 304 which covers the positive electrode active materials 303. The graphene 304 is observed to have a linear shape in the cross-sectional view. The plurality of positive electrode active materials are at least partly surrounded with one sheet of graphene or the plurality of sheets of graphene. That is, the plurality of positive electrode active materials exist within one sheet of graphene or among the plurality of sheets of graphene. Note that in some cases, the graphene has a bag-like shape, and the plurality of positive electrode active materials are surrounded with the bag-like portion. In addition, the positive electrode active materials are in some cases partly not covered with the graphene and exposed.

The desired thickness of the positive electrode active material layer 302 is determined in the range from 20 μm to 100 μm. It is preferable to adjust the thickness of the positive electrode active material layer 302 as appropriate so that a crack and separation do not occur.

Note that the positive electrode active material layer 302 may contain a known binder having a volume 0.1 times to 10 times as large as that of the sheet of graphene, such as acetylene black particles or carbon particles such as carbon nanofibers having a one-dimensional expansion.

As an example of the positive electrode active material, a material whose volume is increased by insertion of carrier ions can be given. When such a material is used, the positive electrode active material layer gets vulnerable and is partly broken by charge and discharge, resulting in lower reliability of a power storage device. However, even when the volume of the positive electrode active material increases by charge and discharge, the graphene partly covers the periphery of the positive electrode active material, which allows prevention of dispersion of the positive electrode active materials and the breakdown of the positive electrode active material layer. That is, the graphene has a function of maintaining the bond between the positive electrode active materials even when the volume of the positive electrode active materials fluctuates by charge and discharge.

The graphene 304 is in contact with the plurality of positive electrode active materials and serves also as a conductive additive. Further, the graphene 304 has a function of holding the positive electrode active material layer 302 capable of absorption and release of carrier ions. Thus, a binder does not have to be mixed into the positive electrode active material layer. Accordingly, the amount of the positive electrode active materials in the positive electrode active material layer can be increased, which allows an increase in discharge capacity of a lithium secondary battery.

Next, a method for forming the positive electrode active material layer 302 will be described.

Slurry containing positive electrode active materials which are particles and graphene oxide is formed. After the positive electrode current collector 301 is coated with the slurry, heating is performed in a reduced atmosphere for reduction treatment so that the positive electrode active materials are baked and oxygen included in the graphene oxide is released to form openings in the graphene, as in the formation method of graphene, which is described in Embodiment 2. Note that oxygen in the graphene oxide is not entirely released and partly remains in the graphene. Through the above steps, the positive electrode active material layer 302 can be formed over the positive electrode current collector 301. Consequently, the positive electrode active material layer has higher conductivity.

Graphene oxide contains oxygen and thus is negatively charged in a polar solvent. As a result, graphene oxides are dispersed. Accordingly, the positive electrode active materials contained in the slurry are not easily aggregated, so that the size of the particle of the positive electrode active material can be prevented from increasing by baking. Thus, the transfer of electrons in the positive electrode active materials is facilitated, resulting in an increase in conductivity of the positive electrode active material layer.

Next, the structure of a lithium secondary battery which is a typical example of a power storage device in this embodiment and a manufacturing method thereof will be described with reference to FIG. 5B.

As described in Embodiment 1, the lithium secondary battery 400 includes a positive electrode 405 including a positive electrode current collector 401 and a positive electrode active material layer 403, a negative electrode 411 including a negative electrode current collector 407 and a negative electrode active material layer 409, and a spacer 413 provided between the positive electrode 405 and the negative electrode 411. Note that an electrolyte 415 is contained in a hole in the spacer 413. Further, the positive electrode current collector 401 is connected to the external terminal 417, and the negative electrode current collector 407 is connected to the external terminal 419. An end portion of the external terminal 419 is embedded in a gasket 421. In other words, the external terminals 417 and 419 are insulated from each other with the gasket 421.

The negative electrode 205 described in Embodiment 1 or the negative electrode 235 or the negative electrode 245 described in Embodiment 2 can be used as appropriate as the negative electrode 411.

As the positive electrode current collector 401 and the positive electrode active material layer 403, the positive electrode current collector 307 and the positive electrode active material layer 309 which are described in this embodiment can be used as appropriate.

As a solute of the electrolyte 415, a material which contains carrier ions is used. Typical examples of the solute of the electrolyte include lithium salts such as LiClO₄, LiAsF₆, LiBF₄, LiPF₆, and Li(C₂F₅SO₂)₂N.

In the case where carrier ions are alkali metal ions other than lithium ions, alkaline-earth metal ions, beryllium ions, or magnesium ions, the solute of the electrolyte 415 may contain, instead of lithium in the lithium salts, an alkali metal (e.g., sodium or potassium), an alkaline-earth metal (e.g., calcium, strontium, or barium), beryllium, or magnesium.

As a solvent for the electrolyte 415, a material in which carrier ions can transfer is used. As the solvent for the electrolyte 415, an aprotic organic solvent is preferably used. Typical examples of the aprotic organic solvent include ethylene carbonate, propylene carbonate, dimethyl carbonate, diethyl carbonate, γ-butyrolactone, acetonitrile, dimethoxyethane, and tetrahydrofuran, and one or more of these materials can be used. When a gelled polymer material is used as the solvent for the electrolyte 415, liquid leakage is less likely to occur and safety is improved. Further, the lithium secondary battery 400 can be thinner and more lightweight. Typical examples of the gelled polymer material include a silicon gel, an acrylic gel, an acrylonitrile gel, polyethylene oxide, polypropylene oxide, and a fluorine-based polymer. Alternatively, the use of one or more of ionic liquids (room temperature molten salts) which are less likely to burn and volatilize as the solvent for the electrolyte 415 can prevent the power storage device from exploding or catching fire even when the power storage device internally shorts out or the internal temperature increases owing to overcharging or the like.

As the electrolyte 415, a solid electrolyte such as Li₃PO₄ can be used.

For the external terminals 417 and 419, a metal member such as a stainless steel plate or an aluminum plate can be used as appropriate.

Note that in this embodiment, a coin-type lithium secondary battery is given as the lithium secondary battery 400; however, any of lithium secondary batteries with a variety of shapes, such as a sealing-type lithium secondary battery, a cylindrical lithium secondary battery, and a square-type lithium secondary battery, can be used. Further, a structure in which a plurality of positive electrodes and a plurality of negative electrodes including spacers are stacked or wound may be employed.

Next, a method for manufacturing the lithium secondary battery 400 described in this embodiment will described.

By the formation method described in any of Embodiments 1 to 3 and this embodiment, the positive electrode 405 and the negative electrode 411 are formed as appropriate.

Then, the positive electrode 405, the negative electrode 411, and the spacer 413 are immersed in the electrolyte 415. Next, the positive electrode 405, the spacer 413, the gasket 421, the negative electrode 411, and the external terminal 417 are stacked in that order over the external terminal 419, and the external terminal 419 and the external terminal 417 are crimped to each other with a “coin cell crimper”. Thus, the coin-type lithium secondary battery can be manufactured.

Note that a washer may be provided between the external terminal 417 and the positive electrode 405 or between the external terminal 419 and the negative electrode 411 to increase the connection area between the external terminal 417 and the positive electrode 405 or the connection area between the external terminal 419 and the negative electrode 411.

This application is based on Japanese Patent Application serial no. 2011-282506 filed with Japan Patent Office on Dec. 23, 2011, the entire contents of which are hereby incorporated by reference.

What is claimed is:

1. A power storage device comprising:
a negative electrode comprising a negative electrode current collector; and
a positive electrode,
wherein the negative electrode current collector comprises a common portion and a first protrusion and a second protrusion,
wherein the first protrusion and the second protrusion protrude from the common portion,
wherein the first protrusion and the second protrusion are adjacent to each other,
wherein a side surface of the first protrusion is covered with a first negative electrode active material layer and a side surface of the second protrusion is covered with a second negative electrode active material layer,
wherein a distance between the first protrusion and the second protrusion is a distance with which the first negative electrode active material layer and the second negative electrode active material layer are in contact with each other by insertion of carrier ions into the first and second negative electrode active material layers, and
wherein the first negative electrode active material layer and the second negative electrode active material layer are in contact with each other when the amount of carrier ions inserted into the first negative electrode active material layer is smaller than the maximum absorption amount of the carrier ions of the first negative electrode active material layer and the amount of carrier ions inserted into the second negative electrode active material layer is smaller than the maximum absorption amount of the carrier ions of the second negative electrode active material layer.

2. The power storage device according to claim 1, wherein the first and second negative electrode active material layers are formed of one or more of silicon, germanium, tin, and aluminum.

3. The power storage device according to claim 1, wherein each of the first and second protrusions has a cylindrical shape, a prismatic shape, or a plate shape.

4. The power storage device according to claim 1, wherein the carrier ion is a lithium ion, a sodium ion, or a potassium ion.

5. The power storage device according to claim 1, wherein a top of the first protrusion is exposed from the first negative electrode active material layer and a top of the second protrusion is exposed from the second negative electrode material layer.

6. The power storage device according to claim 1, wherein the negative electrode current collector comprises a metal or an alloy.

7. A power storage device comprising:
a negative electrode comprising a negative electrode current collector; and
a positive electrode,
wherein the negative electrode current collector comprises a common portion and a first protrusion and a second protrusion,
wherein the first protrusion and the second protrusion protrude from the common portion,
wherein the first protrusion and the second protrusion are adjacent to each other,
wherein a side surface of the first protrusion is covered with a first negative electrode active material layer and a side surface of the second protrusion is covered with a second negative electrode active material layer,
wherein the first negative electrode active material layer is covered with a first surface coating film and the second negative electrode active material layer is covered with a second surface coating film,
wherein a distance between the first protrusion and the second protrusion is a distance with which the first surface coating film and the second surface coating film are in contact with each other by insertion of carrier ions into the first and second negative electrode active material layers, and
wherein the first surface coating film and the second surface coating film are in contact with each other when the amount of carrier ions inserted into the first negative electrode active material layer is smaller than the maximum absorption amount of the carrier ions of the first negative electrode active material layer and the amount of carrier ions inserted into the second negative electrode active material layer is smaller than the maximum absorption amount of the carrier ions of the second negative electrode active material layer.

8. The power storage device according to claim 7, wherein the first and second negative electrode active material layers are formed of one or more of silicon, germanium, tin, and aluminum.

9. The power storage device according to claim 7, wherein each of the first and second protrusions has a cylindrical shape, a prismatic shape, or a plate shape.

10. The power storage device according to claim 7, wherein the carrier ion is a lithium ion, a sodium ion, or a potassium ion.

11. The power storage device according to claim 7, wherein a top of the first protrusion is exposed from the first negative electrode active material layer and a top of the second protrusion is exposed from the second negative electrode material layer.

12. The power storage device according to claim 7, wherein the negative electrode current collector comprises a metal or an alloy.

13. A power storage device comprising:
a negative electrode comprising a negative electrode current collector; and
a positive electrode,
wherein the negative electrode current collector comprises a common portion and a plurality of protrusions protruding from the common portion,
wherein a side surface of each of the plurality of protrusions is covered with a negative electrode active material layer, and
wherein a distance d between centers of adjacent protrusions is expressed by Formula 1,
$$d = 2 \times \{ r + t \times [ \frac{( {α}_{m} - 1 )}{{C}_{i}} \times {C}_{l} + 1 ] \} \qquad [ FORMULA 1 ]$$
where r, t, αₘ, Cᵢ, and Cₗ represent a half of the narrowest width of a top surface shape of the protrusion, a thickness of the negative electrode active material layer in the case where carrier ions are not inserted into the negative electrode active material layer, the maximum rate of increase in volume of the negative electrode active material layer, a theoretical capacity of the negative electrode active material layer, and capacity of the negative electrode active material layer in the case where adjacent negative electrode active material layers are in contact with each other by insertion of the carrier ion into the negative electrode active material layer, respectively.

14. The power storage device according to claim 13, wherein the negative electrode active material layer is formed of one or more of silicon, germanium, tin, and aluminum.

15. The power storage device according to claim 13, wherein the protrusion has a cylindrical shape, a prismatic shape, or a plate shape.

16. The power storage device according to claim 13, wherein the carrier ion is a lithium ion, a sodium ion, or a potassium ion.

17. The power storage device according to claim 13, wherein a top of each of the plurality of protrusions is exposed from the negative electrode active material layer.

18. The power storage device according to claim 13, wherein the negative electrode current collector comprises a metal or an alloy.
